(19) United States
(12) Patent Application Publication
(10) Pub. No.: US 2020/0161925 A1
(43) Pub. Date: May 21, 2020

(54) ELECTRIC MOTOR

(71) Applicant: NSK LTD., Tokyo (JP)

(72) Inventors: Masayuki MARUYAMA, Fujisawa-shi (JP); Kenichi FUKUYAMA, Fujisawa-shi (JP); Hideya HIGUCHI, Fujisawa-shi (JP); Kazunori KOIZUMI, Fujisawa-shi (JP)

(73) Assignee: NSK LTD., Tokyo (JP)

(21) Appl. No.: 16/622,015

(22) PCT Filed: Jun. 28, 2018
(86) PCT No.: PCT/JP2018/024495

§ 371 Date: Dec. 12, 2019

(30) Foreign Application Priority Data
Sep. 19, 2017 (JP) 2017-178756

(51) Int. Cl. H02K 3/52

(52) U.S. Cl. CPC H02K 3/522

(57) ABSTRACT

An electric motor (1) includes a wiring member (20a, 20b), an annular inner housing (10) disposed on an inner circumferential side of a stator (11), and a wiring fixing member (2) formed around the wiring member (20a, 20b). A longitudinal hole (recessed part) (10a, 10d) which opens to one end surface and extends in an axial direction is formed in an outer circumferential edge portion of the inner housing (10), and a level difference (locking part) (12) is formed on an inner circumferential surface of the longitudinal hole. When the wiring member (20a, 20b) is inserted through the longitudinal hole (10a, 10d), the wiring fixing member (2) is locked to the level difference.

### TECHNICAL FIELD

The present invention relates to an electric motor, and more particularly to improvement in a structure of mounting a wiring such as a lead wire connected to a coil of an electric motor.

Priority is claimed on Japanese Patent Application No. 2017-178756, filed Sep. 19, 2017, the content of which is incorporated herein by reference.

### BACKGROUND ART

In an electric motor, for example, as illustrated in FIG. 7, a structure in which a wiring fixing member 33 for fixing a wiring 32 is press-fitted into a recessed part 31 formed by cutting out an outer circumferential surface of a hollow annular inner housing 30, and the wiring fixing member 33 is fixed with bolts 34 has been proposed (see Patent Literature 1).

### CITATION LIST

### Patent Literature

### [Patent Literature 1]

Japanese Patent Application, Publication No. 2007-244096

### SUMMARY OF INVENTION

### Technical Problem

Such a prior art requires not only bolts and taps for fixing metal fittings but also space for disposing parts such as metal fittings, bolts, and the like, and thus the number of parts increases.

An aspect of the present invention aims to provide an electric motor in which the number of parts is relatively small and the work efficiency of mounting a wiring or the like can be improved.

### Solution to Problem

An electric motor according to an aspect of the present invention includes a wiring member, an annular inner housing disposed on an inner circumferential side of a stator, and a wiring fixing member formed around the wiring member, in which a longitudinal hole which opens to one end surface and extends in an axial direction is formed in an outer circumferential edge portion of the inner housing, a level difference is formed on an inner circumferential surface of the longitudinal hole, and, when the wiring member is inserted through the longitudinal hole, the wiring fixing member is locked to the level difference and the wiring member is prevented from coming out of the inner housing.

An electric motor according to another aspect of the present invention includes a housing, a wiring member connected to an electrical part housed in the housing, and a wiring fixing member provided on an outer surface of the wiring member, in which the housing includes a hollow provided to extend in an axial direction of the wiring member and having a wall surface surrounding a portion of the wiring member and the wiring fixing member, and a stopper provided on the wall surface and configured to restrict movement of the wiring fixing member in the axial direction.

### ADVANTAGEOUS EFFECTS OF INVENTION

According to the aspect of the present invention, an electric motor in which the number of parts is relatively small and a work efficiency of mounting a wiring or the like can be improved can be provided.

### BRIEF DESCRIPTION OF DRAWINGS

FIG. 1 is a cross-sectional view in an axial direction of an electric motor according to an embodiment of the present invention.

FIG. 2 is a perspective view illustrating a main portion of the electric motor, in which part (a) of FIG. 2 illustrates a state before a wiring is housed in a resolver side of an inner housing, and part (b) of FIG. 2 illustrates a state after the wiring is housed in the resolver side of the inner housing.

FIG. 3 is a schematic partial enlarged view of the main portion illustrated in FIG. 2, in which parts (a) and (b) illustrate a state before the wiring is housed in the resolver side of the inner housing, and parts (c) and (d) illustrate a state after the wiring is housed in the resolver side of the inner housing.

FIG. 4 is a perspective view of a main portion of the electric motor illustrating a state before a wiring is housed in a motor side of the inner housing.

FIG. 5 is a perspective view of the main portion of the electric motor illustrating a state after the wiring is housed in the motor side of the inner housing.

FIG. 6 is a schematic partial enlarged view of the main portion illustrated in FIG. 5, in which the wiring before being housed is illustrated with virtual lines.

FIG. 7 is a view illustrating a state when a wiring is fixed to an inner housing with a wiring fixing member in an electric motor of a conventional technology.

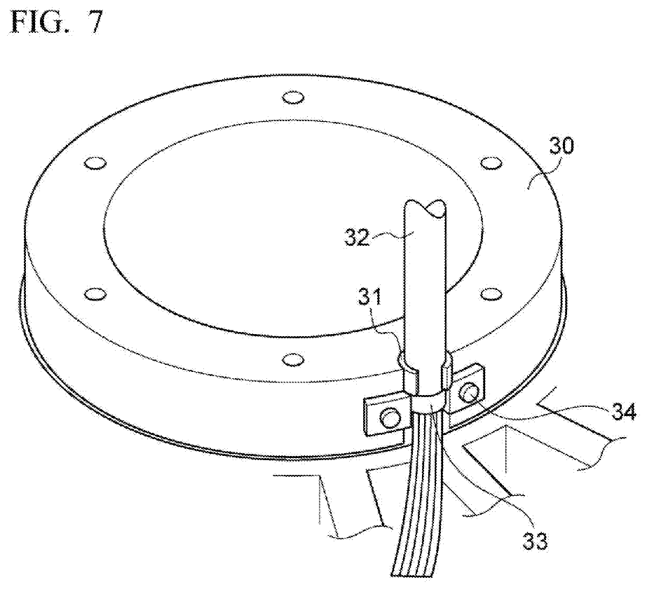

### DESCRIPTION OF EMBODIMENTS

Hereinafter, one embodiment of an electric motor of the present invention will be described with reference to the accompanying drawings. However, the present invention is not limited to the following embodiments, and design modifications can be made within the scope of the present invention.

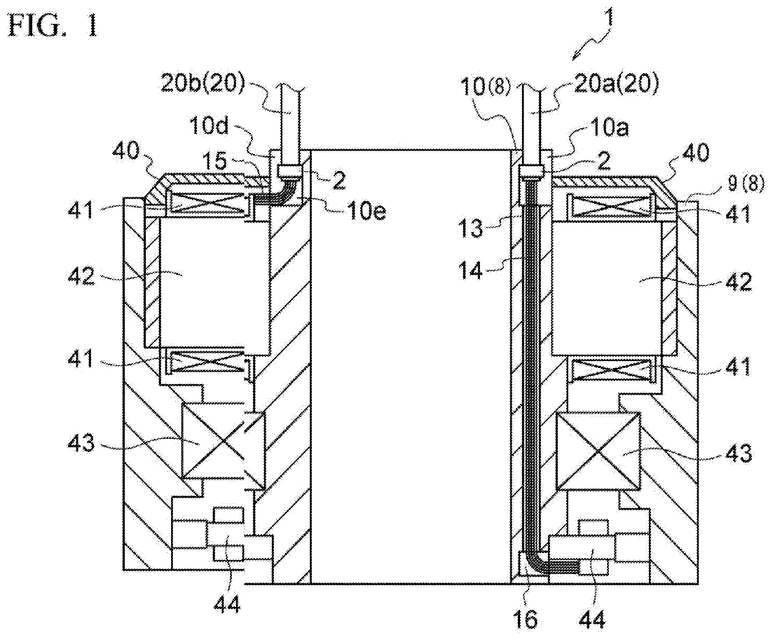

The electric motor 1 employs a direct drive method and includes a housing 8 as illustrated in FIG. 1. Inside the housing 8, the electric motor 1 includes a motor (an example of electrical parts) 42, a bearing 43 for rotatably supporting the motor 42, and a resolver (rotation detector, an example of electrical parts) 44 for detecting a rotation state of the motor 42. The housing 8 includes an inner housing 10 and an outer housing 9. The electric motor 1 has substantially an annular structure as a schematic shape in its entirety. In another embodiment, the motor 1 other than the direct drive method can be applied.

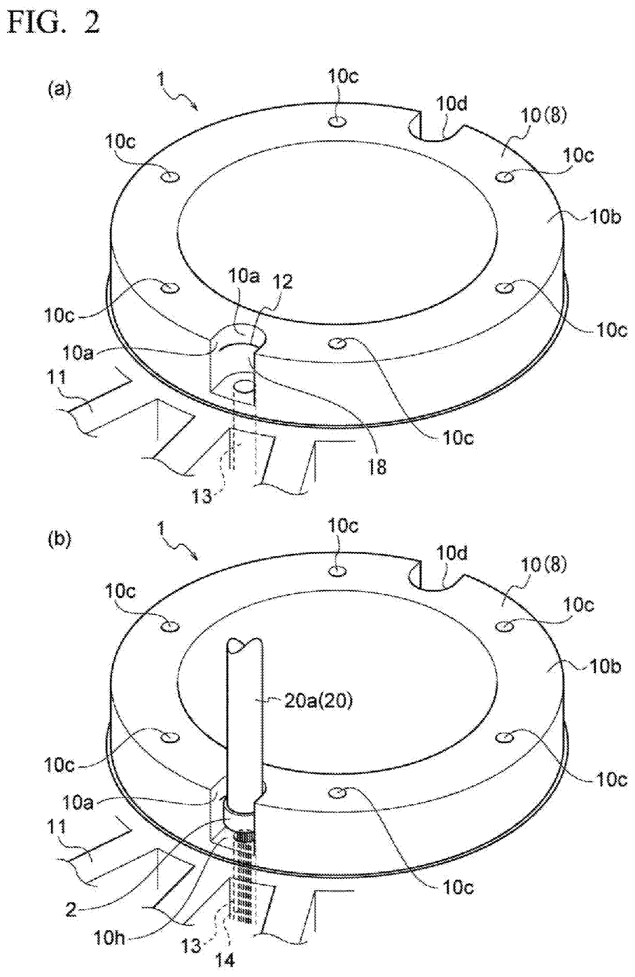

Further, the electric motor 1 includes a stator 11 formed in an annular shape as illustrated in FIG. 2. The inner housing 10 (a portion of the housing 8) is disposed on an inner circumferential side of the stator 11 and is formed in an annular shape. Also, in order to protect a coil (an example of electrical parts) 41 wound around the stator 11, the electric motor 1 includes a motor cover 40 formed of an annular disk member on an upper portion of the stator 11 (see FIG. 1).

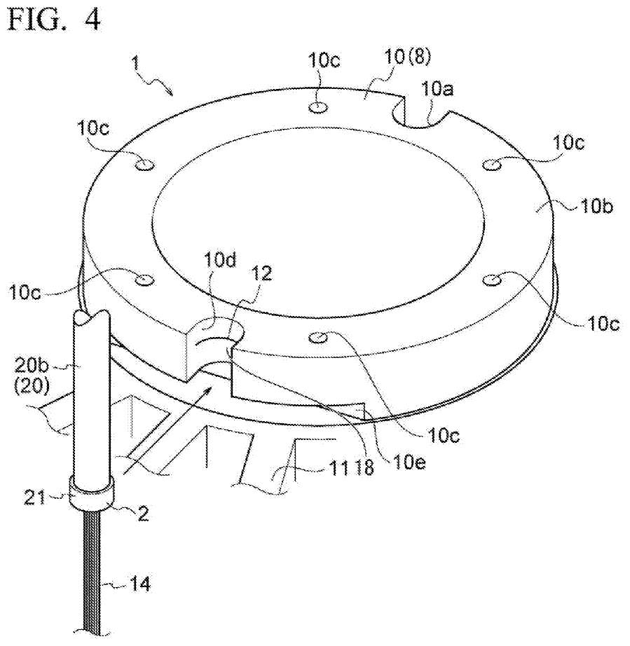

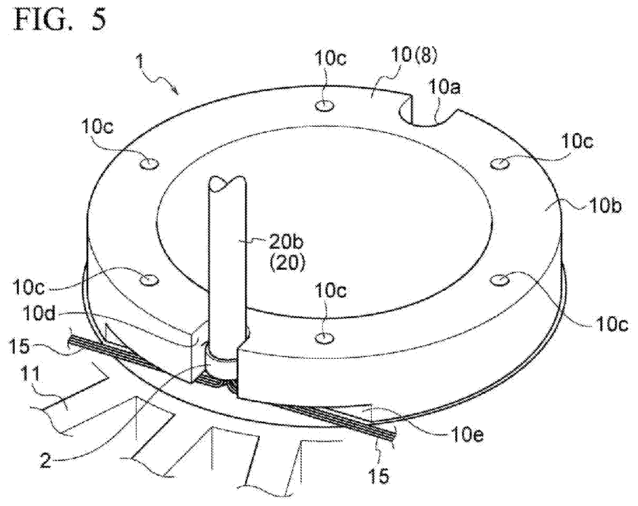

In FIG. 2, illustration of the motor cover 40 and a coil 41 are omitted in order to facilitate understanding of characteristic configurations of the present application. The same applies to FIGS. 4 and 5 to be described below.

A plurality of mounting holes (tap holes) 10c are provided on a motor mounting surface (shaft end surface) 10b of the inner housing 10. On the other hand, bolt insertion holes are provided on a motor mounting base (not illustrated) to which the electric motor 1 is fixed to correspond to the respective mounting holes 10c. The electric motor 1 is fixed to the motor mounting base with bolts using the mounting holes 10c and the bolt insertion holes.

As illustrated in FIG. 1, recessed parts (hollows, notches, wiring housing parts, or wiring housing spaces) 10a and 10d are provided on an outer circumferential surface of the inner housing 10. In one embodiment, the recessed parts 10a and 10d are provided at two positions on the outer circumferential surface of the inner housing 10 at positions of point symmetry. In another embodiment, recessed parts (hollows) can be provided at other positions in the housing 8 alternatively and/or additionally. Also, the number of recessed parts can be 1, 2, 3, 4, or 5 or more.

The recessed parts 10a and 10d are longitudinal holes cut out in an axial direction (downward as viewed in the paper surface) from the motor mounting surface 10b (which is an upper end surface) of the inner housing 10, and a cross section (transverse section) thereof has a U shape with an outer circumferential side being open.

The recessed part (first recessed part) 10a is used as a housing part of a wiring member 20a (also referred to as a resolver wire) connected to a resolver 44 used for rotational position detection (see FIG. 2). The recessed part (second recessed part) 10d is used as a housing part for a wiring member 20b (also referred to as a motor wire) connected to the coil 41 of the stator 11 used for power supply. In another embodiment, a separate recessed part can be provided as a housing part of a wiring member connected to a separate electrical part housed in the housing 8.

When the wiring members 20a and 20b are housed in the recessed parts 10a and 10d as described above, the wiring members 20a and 20b do not protrude from the outer circumferential surface of the inner housing 10, and there is no likelihood of the wiring members 20a and 20b coming in contact with the stator 11.

Hereinafter, a configuration of the inner housing on the resolver wire side, a wiring fixing member, and a configuration of the inner housing on the motor wire side in the present embodiment will be described in sequence.

### [Inner Housing on Resolver Wire Side]

The recessed part 10a is a longitudinal hole cut out in the axial direction from the upper end surface (the motor mounting surface 10b) of the inner housing 10. A lower end portion of the recessed part 10a is connected to a through hole 13. The through hole 13 is a conduit formed in the axial direction (upward as viewed in the paper surface) from a lower end surface of the inner housing 10. A lead wire 14 can be inserted into the through hole 13 (see FIG. 1).

Further, description of a detailed shape of the recessed part 10a (hollow, U-shaped hole) will be given in conjunction with description of a relationship between a wiring fixing member 2 (locked part) and the recessed part 10a (locking part) to be described below. Here, particularly, portions different from those in the inner housing on the motor wire side will be described.

In the motor 1, the resolver 44 is provided below the bearing 43 (an outer circumferential bottom surface of the inner housing 10). The lead wire (cable wire) 14 is inserted through the single cylindrical through hole (conduit) 13 provided inside the inner housing 10, and the resolver 44 and an external sensor device are electrically connected to each other via the lead wire 14.

The through hole (conduit) 13 has a diameter that is approximately the same as or larger than a diameter of a bundle of lead wires 14 so that the bundle of lead wires 14 can be inserted therethrough. One end (starting end) of the through hole (conduit) 13 is connected to the lower end portion of the longitudinal hole (the recessed part 10a) and axially passes through the inner housing 10 on the way. The other end (terminal end) of the through hole (conduit) 13 is formed on the lower end surface of the inner housing 10 and is an opening 16 through which the lead wires 14 can be drawn out from the through hole 13.

In the present embodiment, a configuration in which a position of the resolver 44 is on a bottom surface side of the inner housing 10 is employed. In another embodiment, for example, when a configuration in which the resolver 44 is provided on an upper surface side of the inner housing 10 is employed, the through hole 13 need not necessarily be provided throughout in the axial direction. For example, as illustrated in FIG. 2(b), a configuration in which the lead wires 14 are drawn and wired in a gap (a space 10h from the wiring fixing member 2 to a bottom surface of the recessed part 10a) formed in the recessed part 10a may be employed.

A portion of the lead wires 14 drawn out to an external sensor device is configured such that a portion of the plurality of lead wires 14 on an outer circumferential side is covered with, for example, a flexible tube such as polyvinyl chloride (PVC) in order to be protected from an external environment. In another embodiment, a configuration in which a flexible tube of another material is used, or a configuration different from the configuration in which a flexible tube is used can be applied to the lead wires 14.

### [Wiring Member]

The wiring members 20a and 20b include the wiring fixing member 2 provided on outer surfaces of the wiring members 20a and 20b. The wiring fixing member 2 is an annular member having a predetermined axial length in the axial direction of the wiring members 20a and 20b and a predetermined radial thickness. For example, the wiring fixing member 2 may be bonded to an outer circumference of a tube 20 of each of the wiring members 20a and 20b to be integrated with the tube 20. An outer diameter of the wiring fixing member 2 is larger than that of each of the wiring members 20a and 20b. An axial end (a locked part 21) of the wiring fixing member 2 is disposed in a state in which it protrudes radially outward with respect to an outer circumferential surface of each of the wiring members 20a and 20b. In another embodiment, the wiring fixing member 2 can have a shape other than an annular shape.

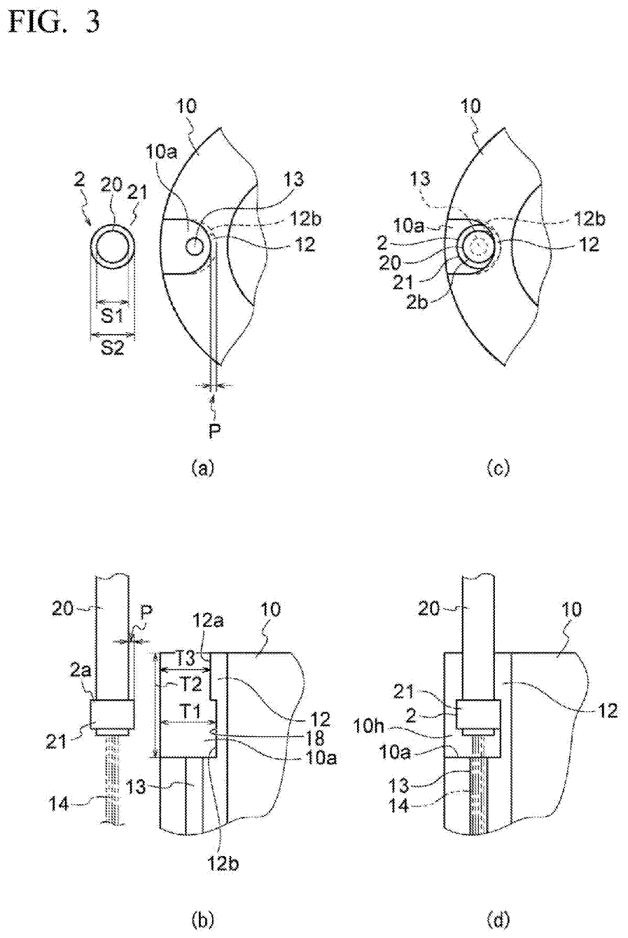

In the present embodiment, the recessed parts 10a and 10d each have a locking part 12 as illustrated in FIGS. 2(a) and 3. The locking part 12 is a level difference provided on inner circumferential surfaces (wall surfaces 18) of the recessed parts (U-shaped holes) 10a and 10d for the wiring members 20a and 20b, and is formed in a U shape in a cross-sectional view. The wiring fixing member 2 is caught and fixed by the level difference of each of the recessed parts 10a and 10d. The recessed parts (hollows) 10a and 10d are provided to extend in the axial direction (axial direction of the housing 8) of the wiring members 20a and 20b. The recessed parts (hollows) 10a and 10d each have a wall surface 18 that surrounds a portion of each of the wiring members 20a and 20b and the wiring fixing member 2. The locking part (a stopper, a level difference (level difference), an anchor, or a hook) 12 that restricts movement of the wiring fixing member 2 in the axial direction of the wiring members 20a and 20b (axial direction of the housing 8) is provided on the wall surface 18. The locking part (stopper) 12 is provided to protrude with respect to the wall surface 18. In one example, an axial end (the locked part 21) of the wiring fixing member 2 is disposed in contact with the locking part (stopper) 12.

Specifically, when the wiring members 20a and 20b are press-fitted into the recessed parts (U-shaped holes) 10a and 10d, a region protruding in a flange shape in a direction perpendicular to the tube 20 of the wiring fixing member 2 functions as the locked part 21, and the wiring members 20a and 20b are each fitted and fixed to the locking part 12. Since movement of the tube 20 more than that is hindered, the wiring members 20a and 20b can be prevented from coming off. An end portion (the locked part 21) of the wiring fixing member 2 is brought into contact with the locking part (stopper) 12, and movement of the wiring members 20a and 20b and the wiring fixing member 2 in the axial direction is restricted. In the recessed part 10a, a distance between an end surface (contact surface) of the locking part 12 and a bottom surface 10h is approximately the same as an axial length of the wiring fixing member 2 or larger than an axial length of the wiring fixing member 2.

In one example, the wiring fixing member 2 (the locked part 21) is made of a resin. In another example, the wiring fixing member 2 may be made of a metal or the like other than a resin.

In another embodiment, a structure in which a recessed part (the locking part 12) is provided on the wall surface 18 of the housing 8, a protruding part (the locked part 21) is provided on the wiring fixing member 2, and the recessed part (the locking part 12) and the protruding part (the locked part 21) are engaged with each other can be employed. Alternatively, a structure in which a protruding part (the locking part 12) is provided on the wall surface 18 of the housing 8, a recessed part (the locked part 21) is provided on the wiring fixing member 2, and the protruding part (the locking part 12) and the recessed part (the locked part 21) are engaged with each other can be employed. In one example, a structure in which the locked part 21 engages with the locking part 12 due to a protrusion and recess (a claw part) fitted to each other may be employed. For example, a structure (a latch structure, a lock structure, or an engagement structure using an elastic body) in which a protruding part fitted to a recessed part provided on an inner circumferential surface on an opening side of the recessed part (U-shaped hole) 10a is provided on an outer circumferential surface of the wiring fixing member 2 (the locked part 21) may be employed. On the contrary, a structure (a latch structure, a lock structure, or an engagement structure using an elastic body) in which a recessed part provided on the outer circumferential surface of the wiring fixing member 2 (the locked part 21) is fitted to and engages with a protruding part provided on the inner circumferential surface of the recessed part (U-shaped hole) 10a may be employed.

In one example, as illustrated in parts (a) and (b) of FIG. 3, the recessed part (U-shaped hole) 10a includes a space part having a length T2 in the axial direction of the inner housing 10. A level difference which is approximately the same as a difference P ((S2−S1)/2) between an outer diameter S1 of the tube 20 and an outer diameter S2 of the locked part 21 is provided on a radially inward region of the wall surface 18 facing the space part. This level difference portion is provided as the locking part 12. The recessed part 10a (the space part) has a first depth T1 in a radial direction and a second depth T3 that is small compared to the first depth T2.

The locking part 12 is provided to form a space in which a portion of the wiring fixing member 2 can be housed in the recessed part (U-shaped hole) 10a. In one example, a first U-shaped hole 12a and a second U-shaped hole 12b are formed as illustrated in parts (a) and (b) of FIG. 3. The second U-shaped hole 12b has a curved surface provided close to an axial center with respect to a curved surface of the first U-shaped hole 12a. For example, the curved surface of the second U-shaped hole 12b may have a contour along an outer circumferential surface of the locked part 21. The difference P between depths of the first U-shaped hole 12a and the second U-shaped hole 12b is the level difference as the locking part 12. A degree of protrusion of the level difference (the difference P) corresponds to a degree of protrusion of the flange of the wiring fixing member 2.

Next, a method of fixing the wiring fixing member 2 will be described with reference to parts (a) to (d) of FIG. 3. Parts (a) and (b) of FIG. 3 indicate a state before being mounted. Parts (c) and (d) of FIG. 3 indicate a state after being mounted. In parts (c) and (d) of FIG. 3, the locked part 21 of the wiring fixing member 2 is caught by the level difference of the difference P of the locking part 12, and the wiring fixing member 2 is mounted to the inner housing 10. That is, the locked part 21 and the locking part 12 are fitted and fixed to each other.

As a method of fixing the wiring fixing member 2, for example, the wiring fixing member 2 may be press-fitted toward an axial center of the recessed part 10a from the state before being mounted illustrated in parts (a) and (b) of FIG. 3. At that time, as illustrated in parts (c) and (d) of FIG. 3, the wiring fixing member 2 is pushed into the recessed part 10a so that a lower surface (shaft end surface) of the level difference at a boundary between the first U-shaped hole 12a and the second U-shaped hole 12b is brought into contact with an upper surface (shaft end surface) of the flange part (the locked part 21) of the wiring fixing member 2.

With this configuration, the wiring fixing member 2 is stably held with respect to the inner housing 10.

Also, since the tube 20 is not pressed when the wiring fixing member 2 is fixed to the recessed part 10a, there is no likelihood that the tube 20 will be subjected to an excessive force and damaged.

In one example, the outer diameter S2 of the locked part 21 and a width of the second U-shaped hole 12b (the first U-shaped hole 12a) of the inner housing 10 are substantially the same. In a case in which a material of the locked part 21 (the wiring fixing member 2) is made of a resin, when the locked part 21 is strongly press-fitted, the locked part 21 is elastically deformed along the second U-shaped hole 12b, and the locked part 21 and the locking part 12 are fitted to each other in the second U-shaped hole 12b. In another example, the material of the locked part 21 (the wiring fixing member 2) can be a material other than a resin. The outer diameter S2 of the locked part 21 can be set to be small compared to the width of the second U-shaped hole 12b (the first U-shaped hole 12a) of the inner housing 10. In this case, a relationship between the distance between the end surface of the locking part 12 and the bottom surface 10h in the recessed part 10a, and the axial length of the wiring fixing member 2 is set so that movement of the wiring fixing member 2 is inhibited according to characteristics of the wirings 20a and 20b such as flexibility.

When the locked part 21 and the locking part 12 are fitted and fixed to each other, even if the wiring fixing member 2 is pulled in a direction away from the inner housing 10, that is, the wiring members 20a and 20b are pulled upward in the axial direction, the locked part 21 is caught by the locking part 12. Therefore, the movement in the axial direction of the wiring fixing member 2 is hindered, and a holding state of the wiring members 20a and 20b is maintained. Thereby, the wiring structure has high reliability without the wiring members 20a and 20b falling off.

As illustrated in FIG. 3, the wall surface 18 of the inner housing 10 (the housing 8) includes a first section SC1, a second section SC2, a third section SC3, and a fourth section SC4 in a circumferential direction (a circumferential direction around the axis of the recessed part 10a) around an axis of the tube (the wiring members 20a and 20b) 20. In the first section SC1, the locking part (stopper) 12 is provided on the wall surface 18. In the second section SC2, the recessed part (hollow) 10a is open (a region without the wall surface 18). The third section SC3 and the fourth section SC4 are non-formation regions of the locking part (stopper) 12 (regions in which the locking part 12 is not formed), and are disposed between the first section SC1 and the second section SC2 in the circumferential direction. The first section SC1 is disposed on a radially inward side of the inner housing 10, and the second section SC2 is disposed on a radially outward side. Mounting work of the wiring members 20a and 20b and the wiring fixing member 2 with respect to the housing 8 (the inner housing 10) via the second section SC2 which is an open region is smoothly executed. The wall surface 18 of the third section SC3 and the wall surface 18 of the fourth section SC4 are disposed to face each other. For example, the wall surface 18 of the third section SC3 and the wall surface 18 of the fourth section SC4 may be disposed substantially parallel to each other. Alternatively, the wall surface 18 of the third section SC3 and the wall surface 18 of the fourth section SC4 are disposed so that a distance therebetween gradually changes in the radial direction. At the time of mounting or removing work, the wiring members 20a and 20b and the wiring fixing member 2 are guided by the wall surface 18 of the third and fourth sections SC3 and SC4, and the work is smoothly executed.

Here, a direct drive motor (hereinafter, referred to as an electric motor) employs a drive method in which a rotational force is directly transmitted to a rotating body without a transmission mechanism such as gears, belts, and rollers interposed, and the rotating body is caused to rotate in a predetermined direction with respect to a rotated body, and is used for a work rotation holding part of a machining device, a drive joint part of a robot, or the like.

In this type of electric motor, in order to make the electric motor output (motor output) as large as possible within a limited volume while an outer shape of a device directly driving a load is made as small as possible, a housing or a wiring lead-out part which do not directly contribute to a motor output are required to be made as small as possible.

According to the electric motor 1 of the present embodiment, since it is not a structure in which a bolt insertion hole is provided and the wiring fixing member is fixed by metal fittings with bolts as in a conventional technology of an electric motor, the number of parts such as bolts and metal fittings can be reduced and thus the electric motor 1 can be realized at low cost. Further, since a space for providing parts such as bolts and metal fittings can be saved, the product can be made compact in its entirety. Also, since the number of parts is small, a work efficiency of mounting the wiring fixing member or the like can be increased. Also, since the wiring fixing member does not have a structure in which metal fittings are fixed with bolts as in a conventional technology of an electric motor, when a force of pulling the wiring is applied, there is no concern of the metal fittings being loosened and parts such as the metal fittings or the bolts being fallen on a rotating portion of the motor.

### [Inner Housing on Motor Wire Side]

Next, a configuration of the inner housing on the motor wire side will be described with reference to FIGS. 4 and 5.

In FIGS. 4 and 5, a recessed part has a notch hole formed in an inverted T-shape as a whole including the recessed part 10d which is a longitudinal hole cut out in the axial direction from an end surface on one side (motor mounting surface 10b) of the inner housing 10, and a recessed part 10e which is a lateral hole communicating with the recessed part 10d of the longitudinal hole and cut out along an outer circumferential surface of the inner housing 10.

Since a relationship between the recessed part 10d of the longitudinal hole and the wiring fixing member 2 is the same as the relationship between the recessed part 10a (locking part) on the resolver wire side and the wiring fixing member 2 described above, description here will be simplified. Hereinafter, particularly, portions different from the configurations on the resolver side of the inner housing 10 will be mainly described.

Since the motor 42 of the electric motor 1 is provided above the bearing 43 in the axial direction on an outward side of the inner housing 10, the through hole 13 (for wiring the resolver wire) as in the resolver wire side is not formed.

As described above, the recessed part 10d which is at a position of point-symmetric with the recessed part 10a and the recessed part 10e in which a portion of the outer circumferential surface is cut out in the circumferential direction are formed in the inner housing 10 on the motor side as illustrated in FIGS. 4 and 5, in which the recessed part 10d which is a longitudinal hole extending in the axial direction to a middle of the outer circumferential surface and the recessed part 10e of a lateral hole which is a notch in a circular arc shape when a cross section (from a lateral side) thereof is viewed communicate with each other and form a T shape as a whole.

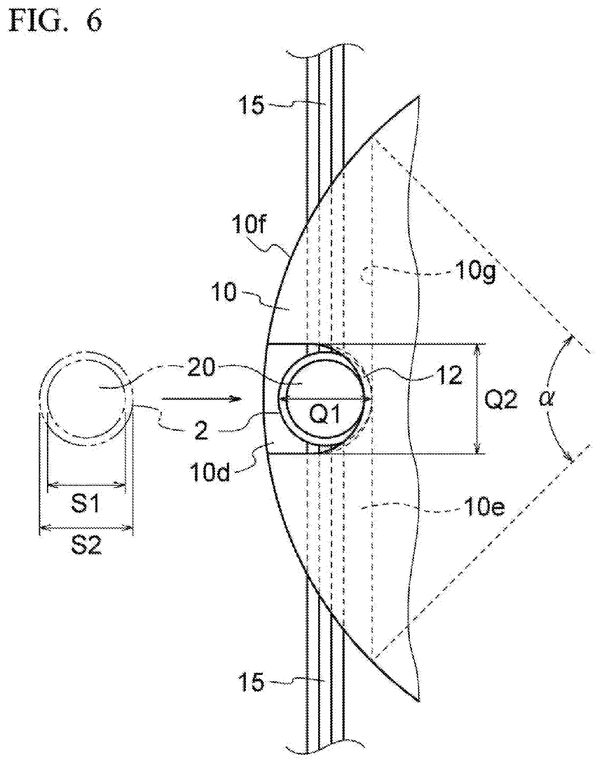

As illustrated in FIG. 6, the recessed part 10e of the lateral hole is cut out in a range of an angle α with an axis of the motor 42 as a center. The range of the angle α is appropriately set according to electric motor product, installation states, or the like.

Also, the recessed part 10e includes a space region (in a horizontal direction) formed at a position of a notch depth Q1 to be surrounded by a circular arc 10f and a chord 10g cut from the outer circumferential surface. An inner diameter at that time is Q2. In the present embodiment, the depth Q1 is at a position having the same depth as the depth T1 in a direction (longitudinal direction in the drawing) toward the axis of the inner housing 10 illustrated in FIG. 3(a).

In the recessed part 10d of the longitudinal hole, the locking part 12 (level difference) is formed to protrude with a predetermined width in the radial direction as in the recessed part 10a (on the resolver wire side). Also, a configuration of the wiring fixing member 2 press-fitted into the recessed part 10d is also the same.

That is, the wiring 20b is locked to the locking part 12 in a state in which a lower surface of the locking part 12 and an upper surface of the wiring fixing member 2 (locked part 21) are in contact with each other.

In the present embodiment, a lead wire 15 is housed in the recessed part 10e and is divided into two left and right sides along the chord 10g of the circular arc shape, and the divided lead wires 15 are connected to the coil 41 of the motor 42.

Further, since the lead wire 15 is wired according to electric motor products or installation conditions, the lead wire 15 is not necessarily limited to be divided only in two directions of left and right. For example, the lead wire 15 may be directed in one direction or divided into directions more than two. Also, a configuration in which wiring is performed in various directions within a range of the angle α of the notch in the recessed part 10e may be employed.

As described above, when the recessed parts 10d and 10e are provided in the inner housing 10 as the housing part of the wiring member 20b, the lead wire 15 can be wired in accordance with a positional structure of the stator of the electric motor 1. Also, since the lead wire 15 can be held without protruding from an outer diameter of the inner housing 10, the electric motor 1 can be configured more compactly. Further, since metal fittings or the like for fixing the wiring as in a conventional case is not required, an efficiency at the time of mounting the wiring can be improved.

### REFERENCE SIGNS LIST

1 Electric motor (direct drive motor)

2 Wiring fixing member

10 Inner housing

10a, 10d Recessed part (longitudinal hole)

11 Stator

12 Locking part (level difference)

13 Through hole

14, 15 Lead wire

16 Opening

20 Tube

20a, 20b Wiring member

21 Locked part

40 Motor cover

41 Coil

42 Motor

43 Bearing

44 Resolver

1. An electric motor comprising:
a stator around which a coil is wound;
a housing including an outer housing and an annular inner housing which is disposed on an inner circumferential side of the stator and extends in an axial direction;
a wiring member connected to an electrical part housed in the housing; and
a wiring fixing member formed around the wiring member, wherein
a longitudinal hole which opens to one end surface and extends in the axial direction is formed in an outer circumferential edge portion of the inner housing,
the longitudinal hole has a U-shaped cross section,
a level difference is formed on an inner circumferential surface of the longitudinal hole,
the wiring fixing member is made of a resin,
the wiring fixing member is fitted into the longitudinal hole; and the wiring fixing member is locked to the level difference,
an outer diameter of the wiring fixing member is small compared to a width of the longitudinal hole,
the wiring fixing member is press-fitted into the longitudinal hole so that the wiring fixing member is elastically deformed, and movement of the wiring fixing member outward in the axial direction with respect to the inner housing is restricted by the level difference.

2. The electric motor according to claim 1, wherein the level difference of the longitudinal hole is configured to restrict movement of the wiring fixing member outward in the axial direction with respect to the inner housing.

3. The electric motor according to claim 1, wherein the wiring fixing member is a flange protruding from an outer circumference of the wiring member.

4. The electric motor according to claim 1, wherein the wiring fixing member has flexibility.

5. The electric motor according to claim 1, wherein
a lateral hole cut out in circumferential direction and extending in a direction intersecting the axial direction is formed on a side surface of the inner housing,
the longitudinal hole and the lateral hole communicate with each other,
the wiring is divided at a position at which the longitudinal hole and the lateral hole communicate with each other,
a portion of the wiring is disposed to extend in a first portion of the lateral hole, and
another portion of the wiring is disposed to extend in a second portion of the lateral hole which is different from the first portion.

6. The electric motor according to claim 1, the electric motor is a direct drive type.

7. An electric motor comprising:
a stator around which a coil is wound;
a housing including an outer housing and an annular inner housing which is disposed on an inner circumferential side of the stator and extends in an axial direction;
a wiring member including a lead wire and a tube protecting the lead wire, wiring member being connected to an electrical part housed in the housing; and
a wiring fixing member provided on an outer surface of the tube of the wiring member, wherein
the inner housing includes
a hollow provided on one end surface of the inner housing to extend in the axial direction,
the hollow includes:
a bottom surface in the axial direction;
a wall surface surrounding a portion of the wiring member and the wiring fixing member; and
a stopper provided to protrude with respect to the wall surface,
the wall surface has a section on a radially outward side which is open between the one end surface of the inner housing and the bottom surface of the hollow,
the wiring fixing member includes a first axial end surface and a second axial end surface on a side opposite to the first shaft end surface,
the first axial end surface is disposed to abut on the stopper so that the first shaft end surface is in contact with the stopper,
a lateral hole cut out in a circumferential direction and extending in a direction intersecting the axial direction is formed on a side surface of the inner housing,
the hollow and the lateral hole communicate with each other,
the wiring is divided at a position at which the hollow and the lateral hole communicate with each other,
a portion of the wiring is disposed to extend in a first portion of the lateral hole,
another portion of the wiring is disposed to extend in a second portion of the lateral hole which is different from the first portion, and
the stopper is configured to restrict movement of the wiring fixing member outward in the axial direction with respect to the inner housing.

8. The electric motor according to claim 13, wherein the wiring fixing member is positioned between the one end surface and the electrical part of the inner housing in the axial direction.

9. The electric motor according to claim 13, wherein, in a predetermined circumferential direction, the wall surface includes:
a first section in which the stopper is partially provided on the wall surface; and
a second section in which the hollow is open.

10. The electric motor according to claim 9, wherein
the wall surface includes a third section and a fourth section which are disposed between the first section and the second section in the predetermined circumferential direction and are regions in which the stopper is not formed, and
the wall surface of the third section and the wall surface of the fourth section are disposed to face each other.

11. The electric motor according to claim 13, wherein a gap in the axial direction is provided between the second axial end surface of the wiring fixing member and the bottom surface of the hollow.

12. The electric motor according to claim 13, wherein the wiring fixing member is made of a resin and is fitted into the hollow.

13. The electric motor according to claim 7, wherein the wiring fixing member is press-fitted into the hollow so that the wiring fixing member is elastically deformed.
